(19) United States
(12) Patent Application Publication
(10) Pub. No.: US 2008/0294973 A1
(43) Pub. Date: Nov. 27, 2008

(54) SYSTEM AND METHOD FOR GENERATING DOCUMENTS FROM MULTIPLE IMAGE OVERLAYS

(76) Inventors: Mohammad SULEIMAN, Trabuco Canyon, CA (US); Silvy Wilson, Rancho Santa Margarita, CA (US); William Su, Riverside, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/751,412

(22) Filed: May 21, 2007

(51) Int. Cl. G06F 17/00

(52) U.S. Cl. 715/202

(57) ABSTRACT

The subject application is directed to a system and method for construction of layered documents, such as advertisements, educational materials, graphic designs, and the like. In multiple image data files generated, for example, by scanning multiple document pages, a user is capable of selecting a color in a particular page, or region of a page, to be eliminated. A user is further capable of selecting a tint level associated with a corresponding image data file, such as, for example, 0%, 50%, and the like. Once desired color transparency data and tint level data are selected, a document processing device generates a composite image by superimposition of each of the image data files. The composite image is generated in accordance with the overlay order designated by the user. A tangible, humanly cognizable document is then generated by the document processing device.

### BACKGROUND OF THE INVENTION

The subject application is directed generally to generation of documents from multiple image files. The application is particularly advantageous in the generation of a composite document output via adjustment of relative image parameters in the multiple images files to facilitate construction of a composite output via layering of the multiple image files.

Often it is desirable to generate a document, such as advertisements, educational materials, graphic designs, signage, placards, or other documents having graphical elements. Such documents are often formed by electronic data images obtained from a plurality of sources. Images may be obtained via scanners, including scanners incorporated into photocopying devices or multifunction peripherals. Images are also suitably obtained from digital cameras, digital archives, CAD programs, word processing programs, graphic design programs, and the like.

Earlier efforts to assemble such documentation spanned from low technology, low quality to complex interaction with complex hardware and software systems. A low technology approach might include clipping of pictures, graphics or text, and positioning them on a platen of a photocopier. A high technology approach might require a user to obtain digitized document data and laboriously import them, then layout and position them on a computer terminal to form a combined output. Often times this approach requires access to complex hardware and software which is required to import, view, edit, position, or output such documents.

### SUMMARY OF THE INVENTION

In accordance with one embodiment of the subject application, there is provided a system and method for generating documents from multiple image files.

Further, in accordance with one embodiment of the subject application, there is provided a system and method for generating a composite document output via adjustment of relative image parameters in the multiple image files to facilitate construction of a composite output via layering of the multiple image files.

Still further, in accordance with one embodiment of the subject application, there is provided a layered document construction system. The system comprises means adapted for receiving a plurality of image data files wherein at least one of the image data files includes transparency data representative of a region having a transparency characteristic associated therewith and means adapted for receiving image property data representative of an image property corresponding to each of the image data files. The system also comprises means adapted for generating a composite image by superimposition of each of the image data files and means adapted for generating output of a generated composite image.

In one embodiment of the subject application, the transparency data includes color transparency data, which color transparency data is representative of at least one color in an associated region which is precluded from presentation.

In another embodiment of the subject application, the image property data includes data representative of a tint level associated with a corresponding image data file.

In yet another embodiment of the subject application, the system further comprises scanner means adapted for generating each of the plurality of image data files from a scan of an associated tangible, humanly cognizable document.

In a further embodiment of the subject application, the system further comprises means adapted for generating a tangible, humanly cognizable document corresponding to the generated composite image.

Still further, in accordance with one embodiment of the subject application, there is provided a method for layered document construction in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a layered document construction system according to one embodiment of the subject application;

FIG. 2 is a block diagram illustrating device hardware for use in the layered document construction system according to one embodiment of the subject application;

FIG. 3 is a functional diagram illustrating the device for use in the layered document construction system according to one embodiment of the subject application;

FIG. 4 is a block diagram illustrating controller hardware for use in the layered document construction system according to one embodiment of the subject application;

FIG. 5 is a functional diagram illustrating the controller for use in the layered document construction system according to one embodiment of the subject application;

FIG. 6 is a flowchart illustrating a layered document construction method according to one embodiment of the subject application;

FIG. 7 is a flowchart illustrating a layered document construction method according to one embodiment of the subject application; and

FIG. 8 illustrates generating of a composite image in accordance with one embodiment of the subject application.

### DETAILED DESCRIPTION OF THE PREFERRED EMBODIMENT

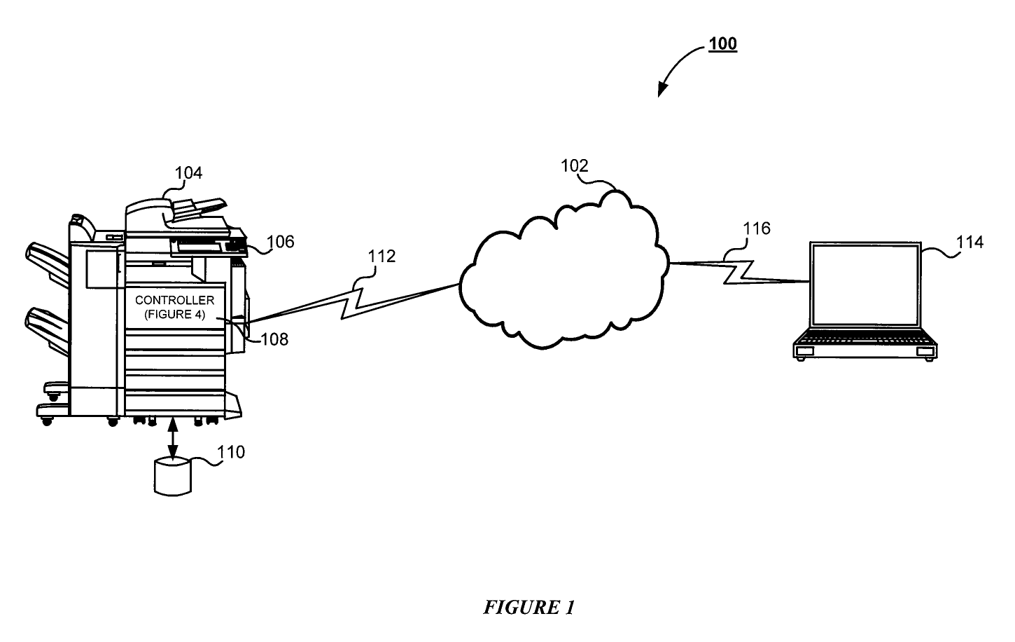

The subject application is directed to a system and method for generating documents from multiple image files. In particular, the subject application is directed to a system and method for generating a composite document output via adjustment of relative image parameters in the multiple image files to facilitate construction of a composite output via layering of the multiple image files. It will become apparent to those skilled in the art that the system and method described herein are suitably adapted to a plurality of varying electronic fields employing image processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a layered document construction system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

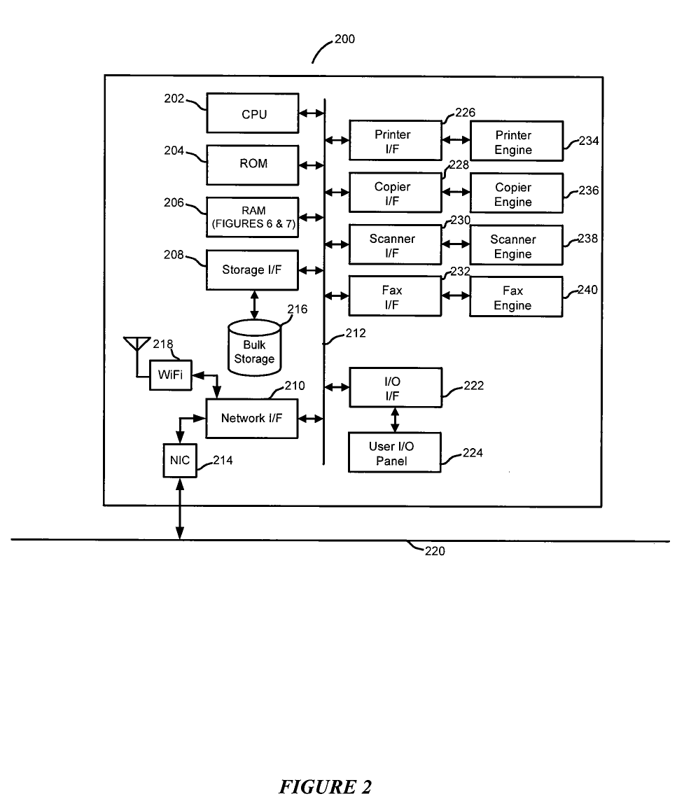

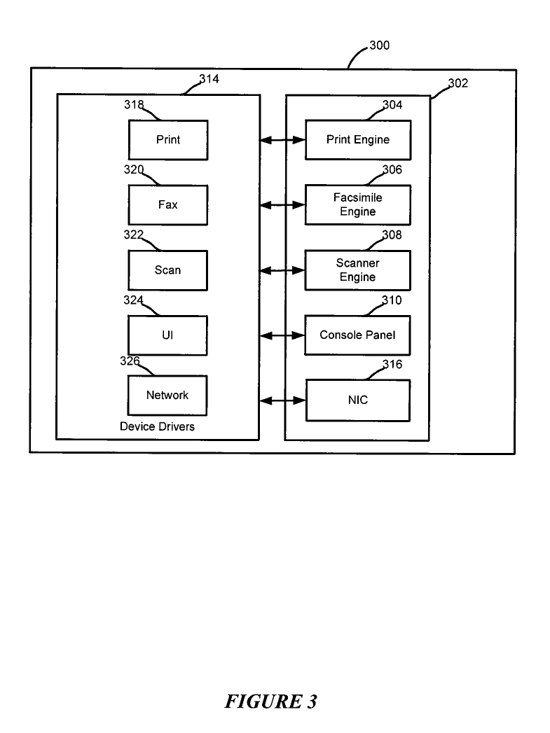

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

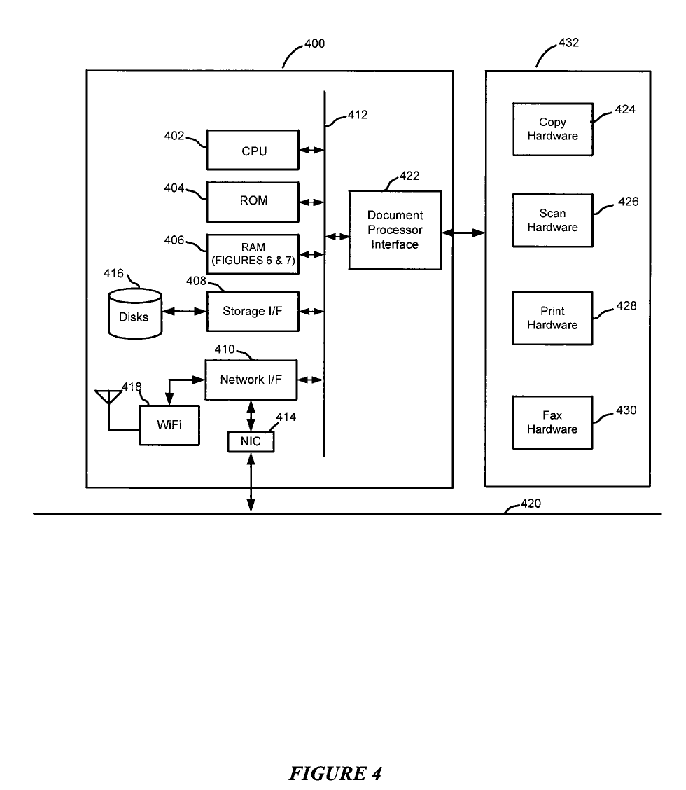

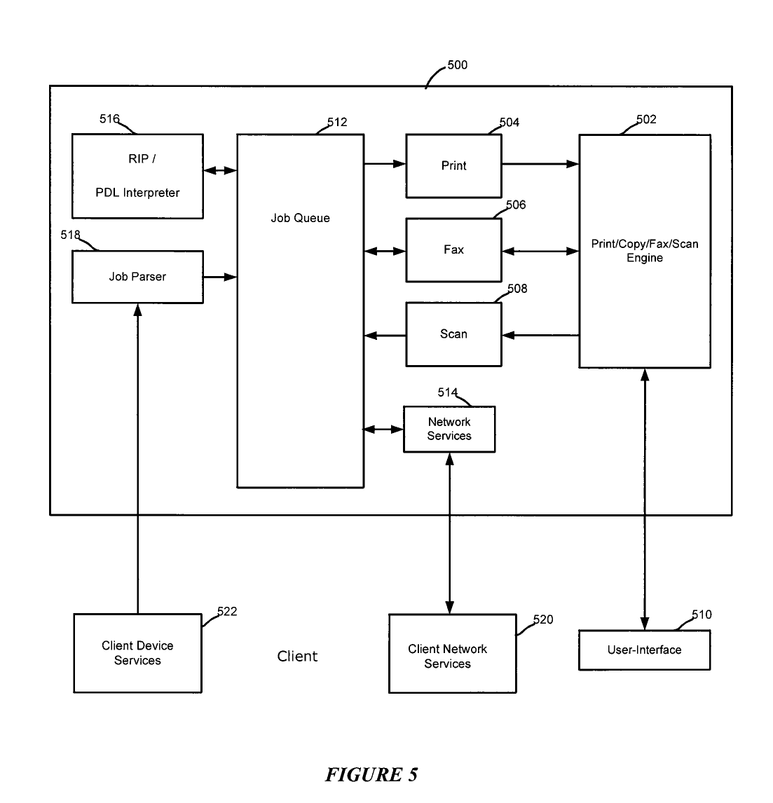

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the layered document construction system and method of the subject application. The functioning of the controller 108 s will better be understood in conjunction with the block diagrams illustrated in FIGS. 4 and 5, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 is advantageously capable of being composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the server 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 108 is representative of any general computing device, known in the art, capable of facilitating the methodologies described herein. Included is a processor 402, suitably comprised of a central processor unit. However, it will be appreciated that the processor 402 is advantageously capable of being composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, a plurality of image data files is first received. At least one of the image data files includes transparency data representative of a region having a transparency characteristic associated therewith. Next, image property data is received, which is representative of an image property corresponding to each of the image data files. A composite image is then generated by superimposition of each of the image data files, the latter being followed by generating output of a generated composite image.

In accordance with one example embodiment of the subject application, the controller 108 associated with the document processing device 104 receives multiple image data files to be used for construction of a composite image. Those skilled in the art will recognize that the image data files are capable of including, for example but without limitation, advertisements, educational materials, graphic designs, and the like. It will be appreciated by those skilled in the art that the image data files are capable of being received via the computer network 102 from the user device 114, or directly via the associated user interface 106. Those skilled in the art will further recognize that the image data files are suitably capable of being obtained from digital cameras, digital archives, CAD programs, word processing programs, graphic design programs, and the like. Images also are capable of being obtained via scanners, including scanners incorporated into photocopying devices or multifunction peripherals.

In accordance with one example embodiment of the subject application, each of the multiple image data files is generated from a scan of an associated tangible, humanly cognizable document, such as, for example, a page of a paper document. Next, the controller 108 associated with the document processing device 104 receives image property data representative of an image property corresponding to each of the image data files. In one embodiment, the image property data includes data representative of a tint level associated with a corresponding image data file.

Hence, before the paper documents are scanned to generate image data files, or image data files are otherwise communicated to the controller 108, an associated user is prompted to input transparency data representative of a region having a transparency characteristic associated therewith, with respect to each image data file. For example, in an embodiment when the multiple image data files are generated by using the scanner engine 308 associated with the document processing device 104, an associated user is prompted to input corresponding transparency data via the associated user interface 106. In one embodiment, the transparency data is representative of at least one color in an associated region which is precluded from presentation, and includes color transparency data. Thus, as will be apparent to a skilled artisan, a color in a particular page, or region of a page, is capable of being selected to be eliminated. An associated user is further prompted to input the image property data including data representative of a tint level associated with a corresponding image data file, such as, for example, 0%, 50%, and the like.

Upon receiving image data files including data representative of a region having a transparency characteristic associated therewith and receiving image property data representative of an image property corresponding to each of the image data files received, the controller 108 generates a composite image. The composite image is generated by superimposition of each of the image data files. As will be recognized by those skilled in the art, prior to generating the composite image, an associated user is prompted, via the associated user interface 106, to input the overlay order to be used for generating the composite image. For example, the overlay order is capable of being defined by the scanning order. In this embodiment, the second page scanned is placed on top of the first page scanned, and the third page scanned is placed on top of the second page, and the like. Alternatively, the overlay order is capable of being otherwise indicated by an associated user.

The controller 108 then generates an output of the generated composite image. Those skilled in the art will appreciate that a tangible, humanly cognizable document corresponding to the generated composite image is capable of being further generated by the controller 108 associated with the document processing device 104. As an example, the document processing device 104 is capable of producing a paper document corresponding to the generated composite image.

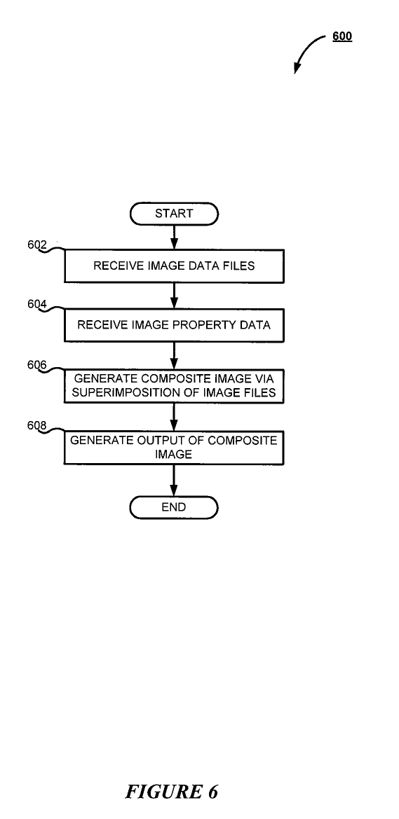

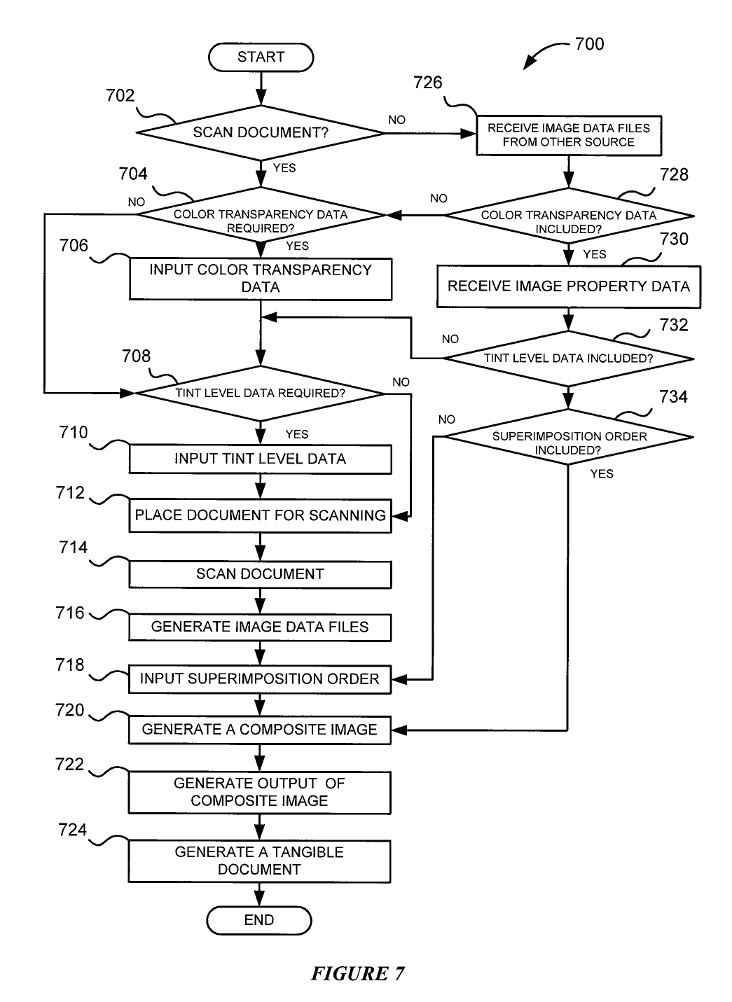

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a layered document construction method from the point-of-view of the document processing device 104 in accordance with one embodiment of the subject application. Beginning at step 602, the controller 108 or other suitable component associated with the document processing device 104 receives image data files. Those skilled in the art will recognize that the image data files are capable of including, for example but without limitation, advertisements, educational materials, graphic designs, and the like. It will be appreciated by those skilled in the art that the image data files are capable of being received via the computer network 102 from the user device 114, or directly via the associated user interface 106.

The image data files are suitably capable of being obtained from digital cameras, digital archives, CAD programs, word processing programs, graphic design programs, and the like. The images also are capable of being obtained via scanners, including scanners incorporated into photocopying devices or multifunction peripherals. The image data files received at step 602, include transparency data representative of a region having a transparency characteristic associated therewith. Transparency data is capable of including, for example, color transparency data representative of at least one color in an associated region which is precluded from presentation. At step 604, the controller 108 or other suitable component associated with the document processing device 104 receives image property data representative of an image property corresponding to each of the image data files. As will be apparent to a skilled artisan, the image property data is capable of being received via the computer network 102 from the user device 114, or directly via the associated user interface 106. The image property data is capable of including data representative of a tint level associated with a corresponding image data file.

At step 606, the controller 108 generates a composite image by superimposition of each of the image data files in accordance with user defined preferences, as will be discussed in greater detail below. Next, at step 608, the controller 108 generates an output of the generated composite image. The document processing device 104, via the controller 108 or other suitable component thereof, then communicates the output of the generated composite image to an associated user.

Referring now to FIG. 7, there is shown a flowchart 700 illustrating a layered document construction method in accordance with another embodiment of the subject application. The method depicted in FIG. 7 begins at step 702, whereupon a determination is made, whether scanning of documents is required. Upon a determination at step 702 that scanning of documents is required, flow proceeds to step 704. At step 704, a determination is made whether color transparency data representative of at least one color in an associated region which is precluded from presentation, is required. When such a determination is positive, flow proceeds to step 706, at which step an associated user is prompted to input color transparency data representative of at least one color in an associated region which is precluded from presentation, via the user interface 106 associated with the document processing device 104. Thus, as will be apparent to a skilled artisan, a color in a particular page, or region of a page, is capable of being selected to be eliminated. Those skilled in the art will recognize that an associated user is also capable of inputting the color transparency data at the user device 114 to be communicated to the document processing device 104 via the computer network 102.

Once color transparency data is input at step 706, flow proceeds to step 708. When no color in a particular page, or region of a page is selected to be eliminated, that is when a determination is made at step 704 that color transparency data is not required, flow proceeds from step 704 to step 708. At step 708, a determination is made whether tint level data associated with a corresponding image data file is required. When such a determination is positive, flow proceeds to step 710, at which step an associated user is prompted to input tint level data associated with a corresponding image data file, such as, for example, 0%, 50%, and the like, via the user interface 106 associated with the document processing device 104. Those skilled in the art will recognize that an associated user is also capable of inputting the color transparency data at the user device 114 to be communicated to the document processing device 104 via the computer network 102. Once tint level data is input at step 710, flow proceeds to step 712.

Returning now to step 708, when a negative determination is made at step 708, that is when no tint level data is required at step 708, flow then proceeds to step 712. At step 712 an associated user is prompted, via the user interface 106 associated with the document processing device 104, to place documents for scanning. Next, at step 714, documents are scanned by the scanner engine 308 associated with the document processing device 104. At step 716, the controller 108 associated with the document processing device 104 generates each of the multiple image data files from a corresponding scan of an associated tangible, humanly cognizable documents.

An associated user is then prompted, at step 718, to input, via the user interface 106 associated with the document processing device 104, the order of superimposition of the image data files. For example, the overlay order is capable of being defined by the scanning order. In this embodiment, the second page scanned is placed on top of the first page scanned, and the third page scanned is placed on top of the second page, and the like. Alternatively, the overlay order is capable of being otherwise indicated by an associated user. For example and without limitation, the superimposition order is capable of being opposite to the order of scanning, or a predefined superimposition sequence is capable of being indicated. Flow then proceeds to step 720, at which step the controller 108 generates a composite image by superimposition of each of the image data files, in accordance with the superimposition order input by an associated user at step 718.

The controller 108 associated with the document processing device 104 generates, at step 722, an output of the generated composite image. Once the output of the composite image is generated, a tangible, humanly cognizable document corresponding to the generated composite image is generated by the document processing device 104 at step 724. As will be recognized by those skilled in the art, the document processing device 104, for example, is capable of producing a paper document corresponding to the generated composite image.

Returning now to step 702, in the event that a determination with respect to a requirement of scanning documents is negative, flow proceeds to step 726. At step 726, the controller 108 associated with the document processing device 104, receives multiple image data files from associated source or sources, such as, for example and without limitation, a digital camera, digital archive, CAD programs, word processing programs, graphic design programs, and the like. The multiple image data files received at step 726 include transparency data representative of a region having a transparency characteristic associated therewith. Flow then proceeds to step 728, whereupon a determination is made, whether color transparency data representative of at least one color in an associated region which is precluded from presentation, is included in the received multiple image data files.

When such determination is negative, flow proceeds to steps 704 through 724 in the manner discussed in detail above. When color transparency data representative of at least one color in an associated region that is precluded from presentation, is included in the received multiple image data files, flow proceeds to step 730. At step 730, the controller 108 associated with the document processing device 104, receives image property data representative of an image property corresponding to each of the image data files from an associated source such as, for example and without limitation, a digital camera, digital archive, CAD programs, word processing programs, graphic design programs, and the like.

Next, at step 732, a determination is made, whether image property data includes data representative of a tint level associated with a corresponding image data file. When such determination is negative, flow proceeds to steps 708 through 724 in the manner discussed in detail above. When such determination is positive, flow proceeds to step 734, at which step a determination is made, whether the order of superimposition of the image data files is included in the received multiple image data files. When such determination is negative, flow proceeds to steps 718 through 724 in the manner discussed in detail above. Upon a positive determination, flow proceeds to steps 720 through 724 in the manner already discussed in detail above.

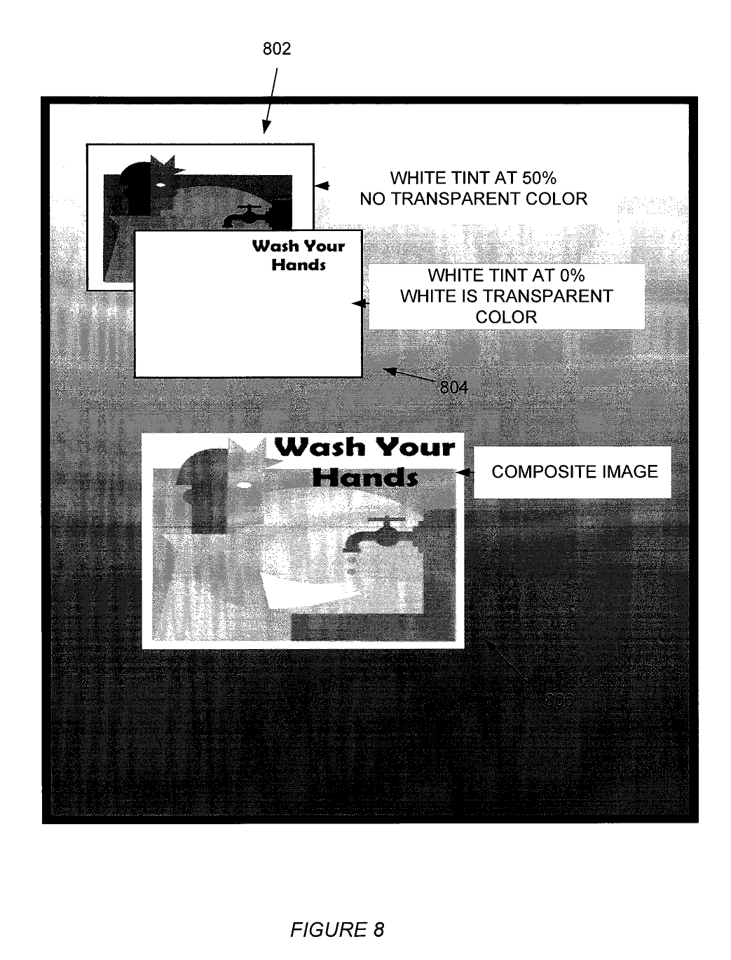

An example of generating a composite image in accordance with the subject application, is illustrated in FIG. 8. In this example, the composite image 806 is generated by superimposition of two layers. As shown in FIG. 8, the first layer 802 includes white tint at 50% and no transparent color. The second layer 804 includes white tint at 0%, wherein white is a transparent color.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A layered document construction system comprising:
means adapted for receiving a plurality of image data files wherein at least one of the image data files includes transparency data representative of a region having a transparency characteristic associated therewith;
means adapted for receiving image property data representative of an image property corresponding to each of the image data files;
means adapted for generating a composite image by superimposition of each of the image data files; and
means adapted for generating output of a generated composite image.

2. The layered document construction system of claim 1 wherein the transparency data includes color transparency data, which color transparency data is representative of at least one color in an associated region which is precluded from presentation.

3. The layered document construction system of claim 1 wherein the image property data includes data representative of a tint level associated with a corresponding image data file.

4. The layered document construction system of claim 2 wherein the image property data includes data representative of a tint level associated with a corresponding image data file.

5. The layered document construction system of claim 1 further comprising scanner means adapted for generating each of the plurality of image data files from a scan of an associated tangible, humanly cognizable document.

6. The layered document construction system of claim 1 further comprising means adapted for generating a tangible, humanly cognizable document corresponding to the generated composite image.

7. A layered document construction method comprising the steps of:
receiving a plurality of image data files wherein at least one of the image data files includes transparency data representative of a region having a transparency characteristic associated therewith;
receiving image property data representative of an image property corresponding to each of the image data files;
generating a composite image by superimposition of each of the image data files; and
generating output of a generated composite image.

8. The layered document construction method of claim 7 wherein the transparency data includes color transparency data, which color transparency data is representative of at least one color in an associated region which is precluded from presentation.

9. The layered document construction method of claim 7 wherein the image property data includes data representative of a tint level associated with a corresponding image data file.

10. The layered document construction method of claim 8 wherein the image property data includes data representative of a tint level associated with a corresponding image data file.

11. The layered document construction method of claim 7 further comprising the step of generating each of the plurality of image data files from a scan of an associated tangible, humanly cognizable document.

12. The layered document construction method of claim 7 further comprising the step of generating a tangible, humanly cognizable document corresponding to the generated composite image.

13. A computer-implemented method for layered document construction comprising the steps of:
receiving a plurality of image data files wherein at least one of the image data files includes transparency data representative of a region having a transparency characteristic associated therewith;
receiving image property data representative of an image property corresponding to each of the image data files;
generating a composite image by superimposition of each of the image data files; and
generating output of a generated composite image.

14. The computer-implemented method for layered document construction of claim 13 wherein the transparency data includes color transparency data, which color transparency data is representative of at least one color in an associated region which is precluded from presentation.

15. The computer-implemented method for layered document construction of claim 13 wherein the image property data includes data representative of a tint level associated with a corresponding image data file.

16. The computer-implemented method for layered document construction of claim 14 wherein the image property data includes data representative of a tint level associated with a corresponding image data file.

17. The computer-implemented method for layered document construction of claim 13 further comprising the step of generating each of the plurality of image data files from a scan of an associated tangible, humanly cognizable document.

18. The computer-implemented method for layered document construction of claim 13 further comprising the step of generating a tangible, humanly cognizable document corresponding to the generated composite image.
